(19) United States
(12) Patent Application Publication
(10) Pub. No.: US 2019/0130444 A1
(43) Pub. Date: May 2, 2019

(54) MODELING CONTENT ITEM QUALITY USING WEIGHTED RANKINGS

(71) Applicant: Facebook, Inc., Menlo Park, CA (US)

(72) Inventors: Zhiye Fei, Cupertino, CA (US); Manas Somaiya, Sunnyvale, CA (US); Tanmoy Chakraborty, Sunnyvale, CA (US); Lei Wang, Santa Clara, CA (US); Taedong Kim, Mountain View, CA (US)

(21) Appl. No.: 15/802,335

(22) Filed: Nov. 2, 2017

(51) Int. Cl. G06Q 30/02; G06F 15/18; G06F 17/30

(52) U.S. Cl. CPC G06Q 30/0251; G06F 15/18; G06F 17/30035; G06Q 50/01; G06F 17/30867; G06Q 30/0275; G06F 17/3053

(57) ABSTRACT

Methods and systems are described herein for predicting the quality of content items for display to a user of an online system. The method involves training a model to predict user values for content items based on ratings provided by a panel of professional raters for a set of content items. The trained model receives embeddings for a viewing user of the online system and for a page associated with a content item along with edge factors representing the viewing user's interactions on the online system and generates a user value representing the predicted quality of the content item for the viewing user. The method further involves combining the predicted user value with a user interaction score for the content item to generate a content item score used to determine whether to display the content item to the viewing user.

### BACKGROUND

The disclosure relates generally to online systems, and in particular to generating a training model to predict the quality of content items using embeddings generated for users and page objectives.

An online system, such as a social networking system, allows its users to connect to and communicate with other online system users. Users may create profiles on an online system that are tied to their identities and use information about the users, such as interests and demographic information. The users may be individuals or entities such as corporations or charities. Because of the increasing popularity of online systems and increasing amount of user-specific information that they maintain, an online system provides an ideal forum for content providers to increase awareness about products or services by presenting content items to online system users as stories in social networking newsfeeds or via other presentation mechanisms.

Users are typically presented with a large number of content items and interact with only a few of the content items received. Users often ignore content items sent by the online system, and as a result, the online system wastes resources by sending the ignored content items. Content providers would prefer to send content to users that are likely to interact with the content.

Generally, the online system relies on ratings from a panel of professional raters to rate the quality of content items and determine which content items to provide to viewing users. Panel ratings are used as inputs to a model that predicts the quality of content items. However, the number of panelists and rated content items is small compared to the number of users of the online system and the number of content items to be evaluated. As a result, the model can overfit the characteristics of the panelist training set and reflect the training set data too specifically, rather than more general characteristics of the population of users and content items, thus rendering the model less effective in predicting the quality of content items with which the panelists have not interacted.

### SUMMARY

To enable the online system to more effectively select content items for display, the online system trains a ratings model to predict whether a content item is likely to be considered of high quality for a viewing user based on embeddings associated with the user and the online system page.

A ratings module of the online system generates training data for the ratings model based on user values provided by a panel of professional raters for a set of content items. Training data includes content items that were determined to be of high quality (i.e., the ratings for the content items exceeded a value threshold) and, in some embodiments, of low quality (i.e., the ratings did not exceed the value threshold).

The trained ratings model receives a content item to evaluate for selection for a first user. In one embodiment, the content item specifies a page of the online system having one or more objectives (e.g., an objective that users “like” the page or share the page with their connections). The ratings model receives input data describing the first user of the online system and the page associated with the content item. In one embodiment, the input data is determined by an embedding module that maps users and pages of the online system to embeddings in a latent space. The embedding module generates embeddings based on users' performance of the desired objective across pages of the online system and sends the particular embedding for the first user and the page associated with the content item to the ratings module for input to the ratings model. The ratings model also receives edge factors for the user representing the first user's interactions on the online system, such as the user's engagement with content items or pages on the online system and the user's affinity for the content provider.

The ratings model uses the embeddings and edge factors to generate a user value representing the predicted quality of the content item for the user and sends the predicted user value to a scoring module for calculation of a content score. The scoring module calculates the content score for the content item based on the predicted user value and a user interaction score indicating a likelihood that users will interact with the content item. If the content score exceeds a content score threshold, a content selection module selects the content item for display to the user.

The features and advantages described in this summary and the following description are not all-inclusive. Many additional features and advantages will be apparent to one of ordinary skill in the art in view of the drawings, specification, and claims herein.

### BRIEF DESCRIPTION OF THE DRAWINGS

FIG. 1 is a block diagram of a system environment for an online system, in accordance with an embodiment.

FIG. 2 is a block diagram of an online system, in accordance with an embodiment.

FIG. 3 is a block diagram illustrating use of the trained ratings model to generate a predicted quality for a content item, in accordance with an embodiment.

FIG. 4 is a flow chart illustrating an example method for generating and using a ratings model to select content items for display to a user, in accordance with an embodiment

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

### Overview

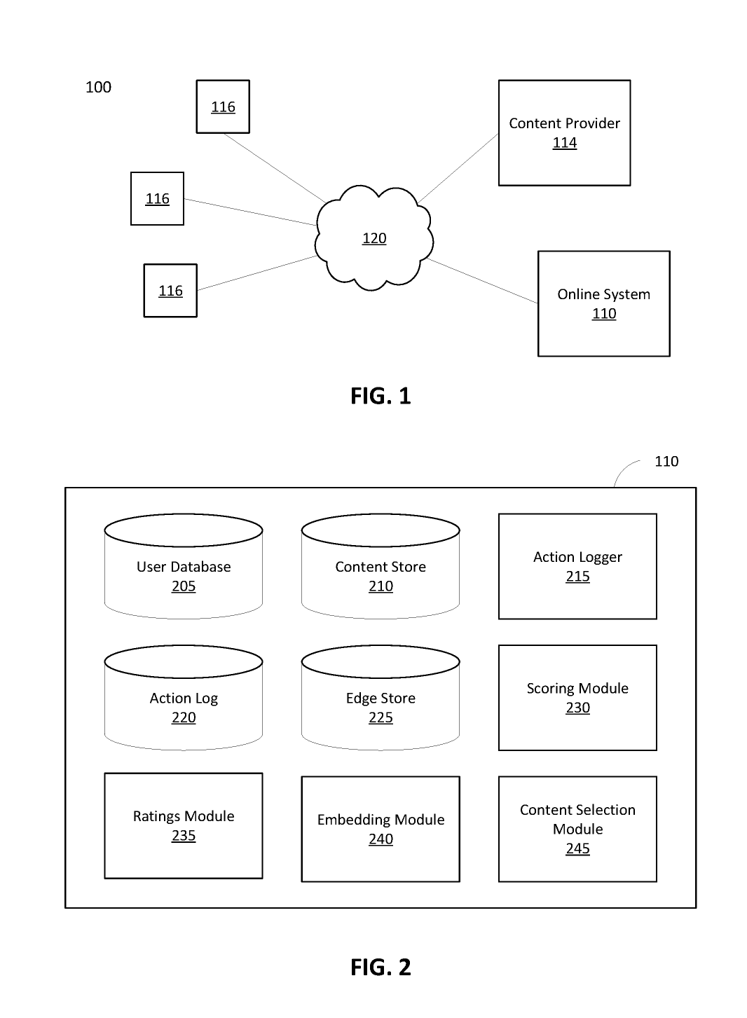

FIG. 1 is a block diagram of a system environment 100 for an online system 110. The system environment 100 shown by FIG. 1 includes one or more content providers 114, one or more client devices 116, and a network 120. In alternative configurations, different and/or additional components may be included in the system environment 100. For example, the online system 110 is a social networking system, a content sharing system, or another system providing content to users.

The content provider 114 produces and manages a set of content items such as videos, images, wiki pages, and advertisements. The content provider 114 provides content items to the online system 110 such that users of the online system 110 can view or interact with the content items. The content items may be used, for example, to promote products, a cause, or other functionalities of the content provider 114. For example, the content provider 114 may be a business organization that provides a social networking system with a series of advertisement items that can be provided to users of the social networking system. As another example, the content provider 114 may be a university that provides a video hosting website with a series of lecture video items that can be accessed by users of the video hosting website.

The client device 116 is a computing device capable of receiving user input as well as communicating via the network 120. While a single client device 116 is illustrated in FIG. 1, in practice many client devices 116 may communicate with the systems in environment 100. In one embodiment, a client device 116 is a conventional computer system, such as a desktop or laptop computer. Alternatively, a client device 116 may be a device having computer functionality, such as a personal digital assistant (PDA), a mobile telephone, a smartphone or another suitable device. A client device 116 is configured to communicate via the network 120.

Users of the online system 110 can interact with the online system 110 through the client devices 116. Specifically, a user of a client device 116 may view or interact with content items through the online system 110. For example, a user may view videos on a video hosting system, or click on an advertisement provided by a social networking system. In one embodiment, a client device 116 executes an application allowing a user of the client device 116 to interact with the online system 110. For example, a client device 116 executes a browser application to enable interaction between the client device 116 and the online system 110. In another embodiment, a client device 116 interacts with the online system 110 through an application programming interface (API) running on a native operating system of the client device 116, such as IOS® or ANDROID™.

In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

FIG. 2 is an example block diagram of an architecture of the online system 110, in accordance with an embodiment. In the embodiment shown in FIG. 2, the online system 110 includes a user database 205, a content store 210, an action logger 215, an action log 220, an edge store 225, a scoring module 230, a ratings module 235, an embedding module 240, and a content selection module 245. In other embodiments, the online system 110 may include additional, fewer, or different components for various applications. Conventional components such as network interfaces, security functions, load balancers, failover servers, management and network operations consoles, and the like are not shown so as not to obscure the details of the system architecture.

Each user of the online system 110 is associated with a user profile, which is stored in the user database 205. A user profile includes declarative information about the user that was explicitly shared by the user and may also include profile information inferred by the online system 110. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location, and the like. A user profile may also store other information provided by the user, for example, images or videos. In certain embodiments, images of users may be tagged with information identifying the online system users displayed in an image. In another embodiment, a user profile in the user database 205 maintains references to actions performed by the corresponding user on content items stored in the content store 210 and stores those actions in the action log 220.

While user profiles in the user database 205 are frequently associated with individuals, allowing individuals to interact with each other via the online system 110, user profiles may also be stored for entities such as businesses or organizations. This allows an entity to establish a presence on the online system 110 for connecting and exchanging content with other online system users. The entity may post information about itself, about its products, or provide other information to users of the online system 110 using a brand page associated with the entity's user profile. Other users of the online system 110 may connect to the brand page to receive information posted to the brand page or to receive information from the brand page. A user profile associated with the brand page may include information about the entity itself, providing users with background or information data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 110, events, groups, or applications. In some embodiments, objects are received from third-party applications or third-party applications separate from the online system 110. In one embodiment, objects in the content store 210 represent single pieces of content, or content “items.” Hence, users of the online system 110 are encouraged to communicate with each other by posting text and content items of various types of media to the online system 110 through various communication channels. This increases the amount of interaction of users with each other and increases the frequency with which users interact within the online system 110.

One or more content items included in the content store 210 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 110 if content in the content item is presented to a user, if the content in the content item receives a user interaction when presented, or if any suitable condition is satisfied when content in the content item is presented to a user. For example, the bid amount included in a content item specifies a monetary amount that the online system 110 receives from a user who provided the content item to the online system 110 if content in the content item is displayed. In some embodiments, the expected value to the online system 110 of presenting the content from the content item may be determined by multiplying the bid amount by a probability of the content of the content item being accessed by a user.

In various embodiments, a content item includes various components capable of being identified and retrieved by the online system 110. Example components of a content item include: a title, text data, image data, audio data, video data, a landing page, a user associated with the content item, or any other suitable information. The online system 110 may retrieve one or more specific components of a content item for presentation in some embodiments. For example, the online system 110 may identify a title and an image from a content item and provide the title and the image for presentation rather than the content item in its entirety.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 110 logs interactions between users presented with the content item or with objects associated with the content item. Additionally, the online system 110 receives compensation from a user associated with content item as online system users perform interactions with a content item that satisfy the objective included in the content item.

Additionally, a content item may include one or more targeting criteria specified by the user who provided the content item to the online system 110. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In one embodiment, targeting criteria may specify actions or types of connections between a user and another user or object of the online system 110. Targeting criteria may also specify interactions between a user and objects performed external to the online system 110, such as on a third-party system (not shown). For example, targeting criteria identify users that have taken a particular action, such as sent a message to another user, used an application, joined a group, left a group, joined an event, generated an event description, purchased or reviewed a product or service using an online marketplace, requested information from a third-party system, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 110, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action logger 215 is used by the online system 110 to track user actions on the online system 110, as well as actions on third-party systems that communicate information to the online system 110. Users may interact with various objects on the online system 110, and information describing these interactions is stored in the action log 220. Examples of interactions with objects include commenting on posts, sharing links, checking-in to physical locations via a mobile device, accessing content items, and any other suitable interactions. Additional examples of interactions with objects on the online system 110 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action logger 215 may record a user's interactions with advertisements of the online system 110 as well as with other applications operating on the online system 110. In some embodiments, data from the action log 220 is used to infer interests or preferences of a user, augmenting the interests included in the user's profile and allowing a more complete understanding of user preferences.

In one embodiment, the action log 220 also stores user actions taken on a third-party system, such as an external website, and communicated to the online system 110. For example, an e-commerce website may recognize a user of an online system 110 through a social plug-in enabling the e-commerce website to identify the user of the online system 110. Because users of the online system 110 are uniquely identifiable, e-commerce websites, such as in the preceding example, may communicate information about a user's actions outside of the online system 110 to the online system 110 for association with the user. Hence, the action logger 215 may record information about actions users perform on a third-party system, including webpage viewing histories, content items that were engaged, purchases made, and other patterns from shopping and buying.

The edge store 225 stores information describing connections between users and other objects of the online system 110 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 110, such as expressing interest in a page on the online system 110, sharing a link with other users of the online system 110, and commenting on posts made by other users of the online system 110. Users and objects can be represented as nodes connected by these edges in a social graph. Once a user has interacted with an object, the edge in the graph links that user with that object, and this link can be used in the future to serve other content to the user related to that object to which the user has a connection.

An edge includes various features each representing characteristics of interactions between users, interactions between users and objects, or interactions between objects. For example, features included in an edge describe the rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 110, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. In one embodiment, affinity scores, or “affinities,” are computed by the online system 110 over time to approximate a user's interest in an object or another user in the online system 110 based on the actions performed by the user. A user's affinity may be computed by the online system 110 over time to approximate a user's affinity for an object, interest, and other users in the online system 110 based on the actions performed by the user. Multiple interactions between a user and a specific object may be stored as a single edge in the edge store 225, in one embodiment. Alternatively, each interaction between a user and a specific object is stored as a separate edge. In some embodiments, connections between users may be stored in the user database 205, or the user database 205 may access the edge store 225 to determine connections between users.

The scoring module 230 generates a content score for each content item provided by the set of content providers 114. The content items may be for example, video, images, wiki pages, advertisements, and the like. For example, the online system 110 may be a video hosting website that provides users with a collection of videos associated with a set of content providers 114 that produce and distribute videos. For example, a series of jewelry making tutorial videos may be uploaded to the video hosting website by a jewelry business.

In one embodiment, the content score calculated by the scoring module 230 is based on a user interaction score and a user value for the content item. The user interaction score reflects a likelihood that a user will interact with the content item either by carrying out the desired objective and/or otherwise performing an action associated with the content item. This may be determined based on a predictive model according to various user characteristics and/or content item characteristics. In some embodiments, the user interaction score is affected by a value (e.g., a bid amount) associated with the user action associated with the content item.

In some embodiments, the user value for a content item is based on a weighted rating received from a panel of raters. The panel of raters rates the quality of each content item on a linear scale, such as 1-5. In one embodiment, the online system 110 uses a non-linear model that adjusts the weights of content items to increase the effect of ratings at the high and low end of the linear scale. For example, if a panel assigns a rating of “1” to a content item, the non-linear model will assign a heavy minus score to the content item. Conversely, the non-linear model can also increase the weight of content items that were rated highly by panelists.

In other embodiments, the user value can be generated by a ratings model that predicts the quality of a content item that has or has not been rated by the panel of raters. The ratings module 235 applies machine learning techniques to generate the ratings model that when applied to content items outputs indications of whether the content items have the associated property, i.e., whether the content item has a predicted user value over a value threshold.

To generate the ratings model, the ratings module 235 forms a training set of content items by identifying a positive training set of content items that have been determined to satisfy the value threshold, and, in some embodiments, forms a negative training set of content items that do not satisfy the value threshold. The training set of content items are identified based on ratings assigned from the panel of raters.

The ratings module 235 extracts feature vectors from the content items of the training set, the features being variables deemed potentially relevant to whether the content items have predicted user values over a value threshold. Specifically, the feature vectors extracted by the ratings module 235 include keywords from textual content items or textual tags; color, texture, motion rigidity, or audio from video content items, etc. An ordered list of the features for a content item is herein referred to as the feature vector for the content item. In one embodiment, the ratings module 235 applies dimensionality reduction (e.g., via linear discriminant analysis (LDA), principle component analysis (PCA), or the like) to reduce the amount of data in the feature vectors for content items to a smaller, more representative set of data.

The ratings module 235 uses supervised machine learning to train the ratings model, with the feature vectors of the positive training set and, in some embodiments, from the negative training set, serving as the inputs. Different machine learning techniques—such as linear support vector machine (linear SVM), boosting for other algorithms (e.g., AdaBoost), neural networks, logistic regression, naïve Bayes, memory-based learning, random forests, bagged trees, decision trees, boosted trees, or boosted stumps—may be used in different embodiments. The ratings model, when applied to the feature vector extracted from a content item, outputs an indication of whether the content item has the property in question, such as a scalar value representing a predicted user value for the content item.

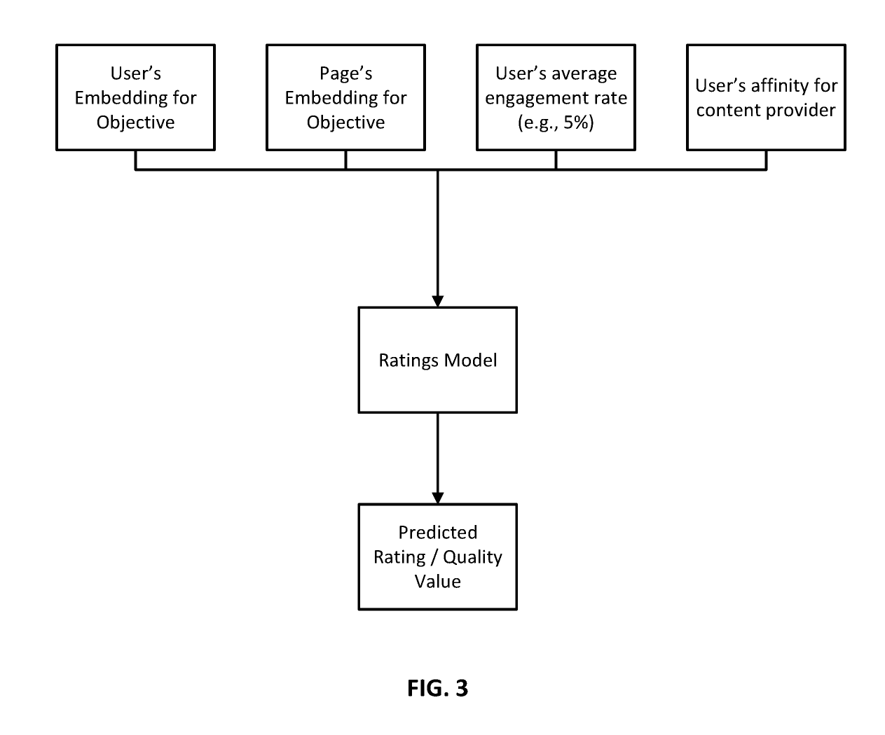

Once trained, the ratings model uses as input embeddings for a first user and an online system page and edge factors for the first user to generate a predicted quality for a content item, as shown in FIG. 3. The embedding module 240 maps users and pages to embeddings in a latent space. In one embodiment, embeddings are generated with respect to a particular objective for the page associated with the content item. Page objectives may be based on input from the content provider associated with the page. For example, a content provider might specify that an objective for a page is a user “liking” the page or following a link on the page to a third-party website associated with the content provider. The embedding module 240 then generates embeddings based on a co-occurrence of users performing an action for the objective with respect to pages of the online system 110 and sends the particular embedding for the first user and for the page associated with the content item to the ratings module 235 for input to the ratings model.

The ratings model also receives edge factors for the user representing the user's interactions on the online system 100. For example, the edge factors might include the user's organic engagement with content items or pages on the online system 110. For example, in one embodiment, the edge factors may be represented as a percentage, e.g., 5%, representing that the user engages with approximately 5% of content items or pages displayed to the user, such as by commenting on, sharing, or “liking” the content items or pages.

Additionally, the user's affinity for the content provider is input to the ratings model and is expressed as an affinity score. In one embodiment, the affinity represents the user's interest in the content provider generally such that the affinity score is computed based on the actions performed by the user on the online system 110 and on third-party systems associated with the content item. In another embodiment, the affinity represents the user's interest in the online system page associated with the content item, and the affinity score is computed based on the user's interactions with the page (e.g., “liking” the page, sharing the page, following a link on the page).

The ratings model uses the input associated with the user and the page to generate a user value representing the predicted quality of the content item. In one embodiment, the content item is determined to be of high quality if the user value for the content item exceeds a value threshold. The ratings model can use either a linear subsidy or non-linear model to set the value threshold and determine whether a content item is of high quality. For example, if the ratings model uses a linear subsidy, a content item may be determined to be of high quality if the predicted user value is 3 or higher. Conversely, if the ratings model uses a non-linear model to adjust the weight of the content item, a content item may be determined to be of high quality if the predicted user value is 0 or higher.

The ratings model sends the predicted user value for the content item to the scoring model 230 for calculation of the content score.

The scoring module 230 then combines the predicted user value and the user interaction score to generate the content score for each content item. If the content score exceeds a content score threshold, the content selection module 245 selects the content item for display to the user through the client device 116. In some embodiments, the ratings model may periodically recalculate the user value for a content item, for example, in response to a change in the user's average engagement rate and/or affinity score for the content provider. Similarly, the online system 110 may receive an updated user interaction score, for example, if the likelihood that users will perform the desired objective changes. Thus, a content item that is initially determined to be of low quality and/or has a content score below the content score threshold may be selected for display to a user if an updated user value and/or user interaction score causes an updated content score to exceed the content score threshold.

### Flow Diagram

FIG. 3 is a flow diagram illustrating use of the ratings model to generate a predicted quality for a content item, in accordance with an embodiment. The ratings module 235 uses machine learning techniques to generate and train the ratings model to output predicted user values that indicate whether a content item is of high or low quality. In one embodiment, the ratings model is trained using a training set of content items that have been rated by a panel of raters (e.g., on a scale of 1-5).

To determine whether a content item is likely to have a high user value for a first user of the online system 110, the ratings model receives input data regarding the first user and an online system page associated with the content item.

In one embodiment, the input includes the user's embedding for the objective and the page's embedding for the objective, which are determined based on all users of the online system 110 fulfilling the objective for the online system page associated with the content item. For example, a content provider might specify that the objective for a page is a user sharing the page with her connections on the online system 110. The embedding module 240 then generates an embedding based on users' performance of the “share” action on online system pages generally and sends the particular embedding for the first user and the page to the ratings module 235 for input to the ratings model. In some embodiments, an embedding is generated based on the objective for the content item. In other embodiments, the embedding module 240 generates an embedding for the objective that is most similar to the objective of the content item.

The ratings model also uses data associated with the first user in determining whether the content item is likely to be of high quality for the user. For example, in one embodiment, the ratings model receives edge factors representing the user's interactions on the online system 110, such as the user's engagement with content items or pages of the online system 110. The edge factors can be represented as a percentage and can indicate, for example, that the user interacts with approximately 5% of content items or pages displayed to the user on the online system 110. Additional input to the ratings model includes the user's affinity for the content provider, as discussed above with respect to FIG. 2.

The ratings model uses the input data to calculate a predicted user value for the content item representing the predicted rating that the first user would assign to the content item and sends the predicted user value to the scoring module 230 for calculation a content score.

### Exemplary Method

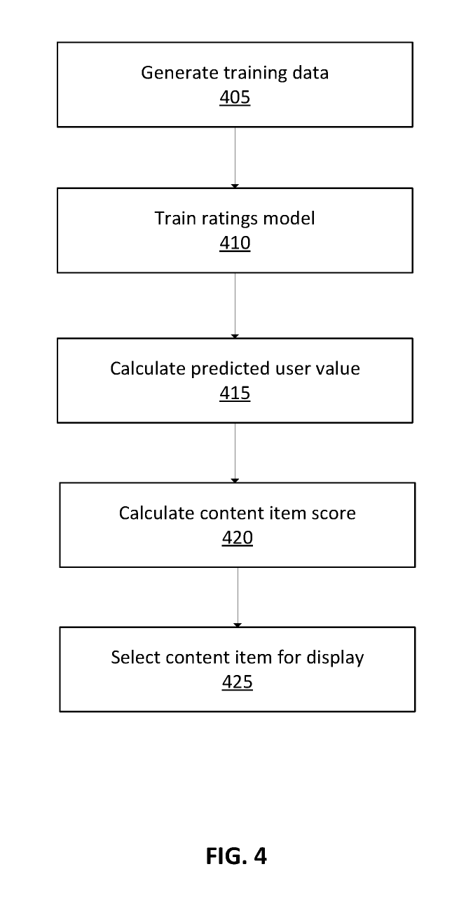

FIG. 4 is a flow chart illustrating an example method for generating and using a ratings model to select content items for display to a user, in accordance with an embodiment.

At 405, the ratings module 235 generates training data for a ratings model based on user values provided by a panel of professional raters. In one embodiment, the content items are rated on a linear scale, such as 1-5, where a value of “1” indicates that the content item is of the lowest quality and a value of “5” indicates that the content item is of the highest quality. In other embodiments, the online system 110 applies a non-linear model to adjust the weight of a content item, as discussed above with respect to FIG. 2.

The ratings module 235 trains 410 the ratings model to output a prediction of whether a content item is of high quality (i.e., whether the user value for the content item exceeds a value threshold). In one embodiment, the ratings module 235 trains the ratings model using positive and negative training sets of content items. A positive training set includes content items that have been determined to satisfy the value threshold (e.g., the value for the content item is at least 3 when using a linear subsidy or at least 0 when using a non-linear model). The negative training set includes content items that do not satisfy the value threshold and are therefore deemed to be of low quality.

Once trained, the ratings model calculates 415 a predicted user value for a content item indicating whether the content item is likely to be of high quality for a first user of the online system 110. In some embodiments, the content item is one that was previously rated by the panel of professional raters. In other embodiments, the content item has not been previously rated. The trained ratings model receives as input embeddings for the first user and for the online system page associated with the content item, as discussed above with respect to FIG. 2. In one embodiment, embeddings are generated with respect to a particular objective for the page (e.g., the user following a link on the page to a third-party website associated with the content provider). Also input to the ratings model are the first user's average engagement rate with content items and pages on the online system 110 and the user's affinity score for the content provider.

The ratings model outputs a predicted user value for the content item and compares the predicted user value to a value threshold to determine whether the content item is likely to be of high quality for the user. The ratings module then sends the user value to the scoring module 230 for calculation of the content score.

At 420, the scoring module 230 calculates a content score by combining the predicted user value and a user interaction score representing a likelihood that users will interact with the content item. Responsive to determining that the content score exceeds a content score threshold, the content selection module 245 selects 425 the content object for display to the user through the client device 116.

### Additional Considerations

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Some embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Finally, the language used in the specification has been principally selected for readability and instructional purposes; it may not have been selected to delineate or circumscribe the inventive subject matter. It is therefore intended that the scope of the embodiments be limited not by this detailed description, but rather by any claims that issue on an application based hereon. Accordingly, the disclosure of the embodiments is intended to be illustrative, but not limiting, of the scope of the embodiments, which is set forth in the following claims.

1. A method comprising:
identifying a content item to evaluate for selection for a user, the content item specifying a page having one or more objectives;
identifying a user embedding for the user and a page embedding for the page, the embeddings generated based on user-page co-occurrence of users performing an action with respect to pages of an online system;
applying the embeddings and one or more edge factors for the user to a trained ratings model to determine a user value indicating the predicted quality of the content item for the user;
determining a user interaction score for the content item reflecting a likelihood of the user interacting with the content item; and
selecting the content item for presentation to the user based on the user value and the user interaction score.

2. The method of claim 1, wherein the ratings model is trained using ratings data received from a panel of raters for a set of content items.

3. The method of claim 1, further comprising using a non-linear model to adjust the user value.

4. The method of claim 1, wherein the edge factors comprise one or more of: an average engagement rate for the user on the online system and the user's affinity for a content provider associated with the content item.

5. The method of claim 1, further comprising:
calculating an updated content score based on one or more of an updated user value and an updated user interaction score; and
responsive to the updated content score exceeding the content score threshold, selecting the content item for display to the user.

6. The method of claim 5, wherein the updated user value is generated in response to one or more of an updated average engagement rate for the user and an updated affinity score for the content provider.

7. The method of claim 1, wherein the user interaction score is affected by a value associated with a user action associated with the content item.

8. A non-transitory computer-readable storage medium storing executable computer program code executable on a processor for:
identifying a content item to evaluate for selection for a user, the content item specifying a page having one or more objectives;
identifying a user embedding for the user and a page embedding for the page, the embeddings generated based on user-page co-occurrence of users performing an action with respect to pages of an online system;
applying the embeddings and one or more edge factors for the user to a trained ratings model to determine a user value indicating the predicted quality of the content item for the user;
determining a user interaction score for the content item reflecting a likelihood of the user interacting with the content item; and
selecting the content item for presentation to the user based on the user value and the user interaction score.

9. The non-transitory computer-readable storage medium of claim 8, wherein the ratings model is trained using ratings data received from a panel of raters for a set of content items.

10. The non-transitory computer-readable storage medium of claim 8, further comprising using a non-linear model to adjust the user value.

11. The non-transitory computer-readable storage medium of claim 8, wherein the edge factors comprise one or more of: an average engagement rate for the user on the online system and the user's affinity for a content provider associated with the content item.

12. The non-transitory computer-readable storage medium of claim 8, further comprising:
calculating an updated content score based on one or more of an updated user value and an updated user interaction score; and
responsive to the updated content score exceeding the content score threshold, selecting the content item for display to the user.

13. The non-transitory computer-readable storage medium of claim 12, wherein the updated user value is generated in response to one or more of an updated average engagement rate for the user and an updated affinity score for the content provider.

14. The non-transitory computer-readable storage medium of claim 8, wherein the user interaction score is affected by a value associated with a user action associated with the content item.

15. An online system comprising:
a processor for executing instructions;
a non-transitory computer-readable storage medium storing instructions executable by the processor, the instructions comprising:
instructions for identifying a content item to evaluate for selection for a user, the content item specifying a page having one or more objectives;
instructions for identifying a user embedding for the user and a page embedding for the page, the embeddings generated based on user-page co-occurrence of users performing an action with respect to pages of an online system;
instructions for applying the embeddings and one or more edge factors for the user to a trained ratings model to determine a user value indicating the predicted quality of the content item for the user;
instructions for determining a user interaction score for the content item reflecting a likelihood of the user interacting with the content item; and
instructions for selecting the content item for presentation to the user based on the user value and the user interaction score.

16. The online system of claim 15, wherein the ratings model is trained using ratings data received from a panel of raters for a set of content items.

17. The online system of claim 15, wherein the edge factors comprise one or more of:
an average engagement rate for the user on the online system and the user's affinity for a content provider associated with the content item.

18. The online system of claim 15, further comprising instructions for:
calculating an updated content score based on one or more of an updated user value and an updated user interaction score; and
responsive to the updated content score exceeding the content score threshold, selecting the content item for display to the user.

19. The online system of claim 18, wherein the updated user value is generated in response to one or more of an updated average engagement rate for the user and an updated affinity score for the content provider.

20. The online system of claim 15, wherein the user interaction score is affected by a value associated with a user action associated with the content item.
